(19) United States
(12) Patent Application Publication
(10) Pub. No.: US 2005/0226985 A1
(43) Pub. Date: Oct. 13, 2005

(54) Method of producing a heat stable oil-in-water emulsion and the products made therefrom

(75) Inventors: Todd Landon, Mound, MN (US); William Joseph Fox, Shoreview, MN (US)

Correspondence Address: WESTMAN CHAMPLIN & KELLY, P.A., SUITE 1600 - INTERNATIONAL CENTRE, 900 SECOND AVENUE SOUTH, MINNEAPOLIS, MN, 55402-3319, US

(73) Assignee: Land O'Lakes, Inc., Arden Hills, MN (US)

(21) Appl. No.: 10/823,480

(22) Filed: Apr. 13, 2004

(51) Int. Cl. A23C 15/00

(52) U.S. Cl. 426/581

(57) ABSTRACT

A method of forming a heat stable oil-in-water emulsion comprises providing a selected amount of an aqueous component comprising more than 50 weight percent water. The aqueous component is optionally heated and a selected amount of a solids component is added to the aqueous component under agitation to form a first intermediate. A selected amount of a milk fat containing component is heated to a temperature sufficient to predominantly melt the fat prior to being to the first intermediate to form a second intermediate. The second intermediate is optionally heated for a selected period of time. The second intermediate is homogenized at between about 250 psig and 5000 psig to form the heat stable oil-in-water emulsion comprising at least 20 weight percent milk fat.

### BACKGROUND OF THE INVENTION

The present invention relates to a food composition and method of producing the food composition. More particularly the present invention relates to a base for a food sauce or the completed food sauce and a method of making the base for the food sauce or the food sauce.

Food sauces such as hollandaise sauce and alfredo sauce are typically made to meet demand at full service restaurants. What is meant by food sauce is a sauce having as principle ingredients edible fat or oil, water and solids in an oil-in-water emulsion where the fat or oil may be added separately, or as a component of any ingredient having fat or oil as a component. Many of the preferred sauces are dairy based food sauces. What is meant by dairy based sauce is a sauce having as principle ingredients milk fat, water and solids in an oil-in-water emulsion where the milk fat may be added separately, or as a component of cream, milk, half & half, butter milk solids, butter or any other ingredient having milk fat as a component. What is meant by fat is an edible lipid or blend containing lipids having sufficient solid fat to resist flowing at room temperature. What is meant by oil is an edible lipid or blend containing lipids having sufficient liquid fat to be fluid (flow at room temperature). Edible lipids or lipid blends being difficult to classify as resisting flow or fluid at room temperature are included in either the term fat or the term oil.

Full service restaurants spend a significant amount of time and skilled labor preparing the food sauces. The food sauces require the correct oil-in-water emulsion having a high volume of the dispersed oil component in the continuous water component to be satisfactory to the diners.

Achieving the desired oil-in-water emulsion with the selected high volume of the fat or oil component requires experimentation and skill. Even after developing a standardized recipe there is no guarantee of success because the oil-in-water emulsion may invert and become an water-in-oil emulsion which is unsatisfactory to diners. When a batch of the dairy based sauce is unacceptable, additional time is required to meet the demand for the sauce, potentially causing stress on the restaurant staff and unnecessary delay to the diner.

Many of the preferred food sauces are not temperature stable. Therefore, large, made from scratch batches of the food sauce cannot be pre-made for use throughout a dining period. Furthermore, when the food sauce is cycled between ambient temperature and a refrigerated temperature, many food sauces have a tendency of “churning out”. What is meant by churning out is an emulsion inversion where the sauce becomes a water-in-oil emulsion where a portion of the water separates from the emulsion. Furthermore, when the food sauces are cycled between a refrigerated temperature or ambient temperature and an elevated cooking temperature the sauces have a tendency of coalescing or “creaming”. By creaming is meant the separation of oil from the water phase where the fat floats on the emulsion. Furthermore, many restaurant food sauces do not exhibit freeze-thaw stability. What is meant by freeze-thaw stability is that when the food sauces are frozen, the food sauce becomes unusable due to churning out, creaming, or complete breakdown of the food sauce emulsion into a discrete aqueous phase and a discrete fat component containing phase. Therefore a full service restaurant has to expend a significant amount of time and resources to produce the food sauces on demand to satisfy its customer's food selections.

### SUMMARY OF THE INVENTION

The present invention includes a method of forming a heat stable oil-in-water emulsion. The method includes providing a selected amount of an aqueous component comprising at least 30 weight percent water. A selected amount of a solids component is added to the aqueous component under agitation to form a first intermediate. A selected amount of a fat containing component is heated to melt the fat and is added to the first intermediate to form a second intermediate. The second intermediate may be heated to between about 130° F. and 150° F. for a selected period of time. The second intermediate is homogenized at between about 250 psig and 5000 psig to form the heat stable oil-in-water emulsion comprising at least 20 weight percent fat.

### DETAILED DESCRIPTION OF THE PREFERRED EMBODIMENTS

The present invention includes a heat stable oil-in-water emulsion that may be used as a base for a food sauce or a completed sauce. A preferred embodiment of the heat stable oil-in-water emulsion is a base for a dairy based sauce. The oil-in-water emulsion and completed sauces therefrom are useful in the food service industry and particularly in a full service restaurant. The present invention also includes a method of producing the heat stable oil-in-water emulsion that may be used as a base for a variety of dairy based sauces, such as, but not limited to, an alfredo sauce, a hollandaise sauce, a Buerre blanc, and a heavy cream sauce.

The heat stable oil-in-water emulsion includes an oil phase that is emulsified within a continuous water phase made up of an aqueous component. Suitable aqueous components include, but are not limited to, water-containing solutions or emulsions or suspensions or solutions or slurries. Often, aqueous components further may include emulsifiers, such as lecithin, Polysorbate 60, or Complemix 100, or proteins, such as aqueous components comprising milk, liquid buttermilk, cream, concentrated milk, concentrated cream. Alternative components suitably optionally included in an aqueous component include, but are not limited to, solutions of plant proteins, such as soy proteins or other oilseed proteins; cocoa proteins, vegetable proteins; powdered buttermilk; milk protein concentrates; and hydrolyzates of any of these. Other suitable aqueous components include oil-in-water emulsions made by rehydrating dried dairy products. Aqueous components may optionally be cultured with a suitable food-grade organism. The emulsion preferably has a greater percentage of an oil phase compared to a water phase on a weight percentage basis.

The oil phase or fat containing component, such as milk fat, contributes between about 20 weight percent and 70 weight percent of the total weight of the oil-in-water emulsion. Preferably, the oil component contributes between about 39 weight percent and 55 weight percent of the total weight of the emulsion. The oil phase or fat containing component is provided as a fluid fat containing component which may be obtained by using oil, such as vegetable oil or a liquid fraction of a fractionated milk fat, or by providing sufficient heat to a fat containing component, such as lard, milk fat or hydrogenated vegetable oil, to melt a sufficient amount of the fat containing component so that the fat containing component becomes fluid. The fat containing component may include emulsifiers, including but not limited to lecithin, mono glycerides, diglycerides, and mixtures of these.

Water is primarily provided in the emulsion with a cream component that also contributes milk fat to the oil component. What is meant by cream is an oil-in-water emulsion containing from about 18 weight percent fat to about 96 weight percent fat dispersed in an aqueous component. Suitable types of oil-in-water emulsions include, but are not limited to, dairy-based creams such as cream, milk, half & half, and oil-in-water emulsions made by rehydrating dried dairy powders or any other ingredient having milk fat as a component. Other suitable creams include oil-in-water emulsions having other edible fats and oils, such as but not limited to soybean oil, palm oil, hydrogenated oils, anhydrous milkfat, and interesterified oils, dispersed in an aqueous component. Depending upon the ingredients used to contribute to the oil component, water may be directly added as an ingredient as needed to provide the desired oil-in-water emulsion. One skilled in the art will also recognize that fat, water and solids can be combined in desired ratios to produce a mixture which has the same composition and physical properties as the aqueous component.

The heat stable oil-in-water emulsion is preferably produced with the aqueous component having about 40 weight percent fat, about 53 weight percent water, about 2.2 weight percent protein, about 2.2 weight percent lactose and about 0.35 weight percent minerals and salt. The heat stable oil-in-water emulsion is more preferably produced with the aqueous component having about 40 weight percent milk fat, about 53 weight percent water, about 2.2 weight percent protein, about 2.2 weight percent lactose and about 0.35 weight percent minerals and salt. The aqueous component contributes between about 10 and 90 weight percent of the total weight of the base and preferably between about 75 weight percent and 85 weight percent of the total weight of the base. Although an aqueous component having about 40 weight percent milk fat is preferred, any aqueous component having more than 18 weight percent fat is within the scope of the present invention. It is also within the scope of the present invention to manufacture an equivalent to the aqueous component by mixing water, solids and a fat containing component to create a desired aqueous component with a selected weight percent solids and fat.

Depending upon the oil content required for the oil-in-water emulsion, additional fat may be added through the addition of a fat containing component. An exemplary fat containing component is an anhydrous milk fat that is substantially 100 weight percent milk fat which may be added in a range of between about 5 weight percent and about 20 weight percent of the total weight of the oil-in-water emulsion. Alternatively, the milk fat containing component may be added with other dairy based ingredients containing milk fat such as butter. Another exemplary fat containing composition comprises vegetable oil or fat such as soybean oil or palm oil; hydrogenated oil, interesterified oil, fractionated oil. A typical composition of butter includes 80 weight percent milk fat, 16 weight percent water, 0.85 weight percent protein, 0.06 weight percent lactose, 2.11 weight percent ash and about 1 weight percent salt. In order to increase the fat concentration of the oil-in-water emulsions the fat containing component must have a greater weight percent fat than the aqueous or cream component.

The heat stable oil-in-water emulsion also contains solids including proteins that may be contained within both the oil phase and the water phase. Suitable solids include materials containing non-fat dry milk, buttermilk solids, milk protein concentrates, dried whey, whey protein concentrates, whey protein isolates, soy proteins, soy protein isolates, cocoa powder, defatted cocoa powder, cheese, or any other form of protein-containing solids. Additional solids are optionally added to the oil-in-water emulsion to increase the body, the viscosity, the thickness and improve the mouthfeel of the base. The amount of solids is determined on a solids non-fat basis (SNF) by the following formula where each of the concentrations is a weight percent of the total weight of the oil-in-water emulsion.
SNF=(protein+carbohydrate+minerals)×100(water+protein+carbohydrate+minerals)
The solids non-fat may reach up to 24 weight percent of the total weight of the emulsion. However, at elevated concentrations, the SNF concentrations may make the emulsion dry, pasty and gummy at refrigerated temperatures.

An exemplary ingredient used to increase the solids in the oil-in-water emulsion is a buttermilk solids component. The buttermilk solids component preferably contributes between about 3 and 10 weight percent of the total weight of the oil-in-water emulsion. The buttermilk powder typically consists of about 49 weight percent carbohydrate, about 34 weight percent protein, about 6 weight percent fat, about 3 weight percent moisture and about 8 weight percent ash and salt. An exemplary buttermilk powder is Land O'Lakes Dry Buttermilk Extra Grade, manufactured by Land O'Lakes of Arden Hills, Minn.

The heat stable oil-in-water emulsion also contains emulsifiers. Water-soluble emulsifiers may be added to the aqueous component, the first intermediate, or the second intermediate, and fat-soluble emulsifiers may be added to the fat containing component. Alternatively, suitable emulsifiers may be added to more than one component or intermediate. A suitable water-soluble emulsifier is Polysorbate 60, and a suitable fat-soluble emulsifier is lecithin. Upon obtaining the desired ratios of oil to water and solids to water and/or oil, the mixture is homogenized and cooled to create a heat stable oil-in-water emulsion. In a preferred embodiment, upon obtaining the desired ratios of oil to water and solids to water and/or oil, the mixture is homogenized and rapidly cooled to create a heat stable oil-in-water emulsion. The oil-in-water emulsion, which includes a greater weight percent of the oil phase in the water phase and the desired solids content, provides a food sauce base that is heat stable and that has the organoleptic properties of a made from scratch diary based sauce. What is meant by heat stable is the ability to be cycled from refrigerated temperature or ambient temperature to cooking temperature and back without churning out or creaming. Churning out is the separation of fat during mechanical agitation, and creaming is the separation of fat from an emulsion either during mechanical agitation or in a static state. The oil-in-water emulsion preferably also exhibits freeze-that stability. What is meant by freeze-thaw stability is the ability to be cycled from ambient temperature to 25° F. and back without churning out or creaming.

Besides water, fat and solids, other non-essential ingredients may also be added such as stabilizers. A non-exhaustive list of stabilizers and emulsifiers includes polysorbate, lecithin, beta carotene (also added for color), sodium benzoate, potassium sorbate, and Complemix 100. The emulsifiers are added to aid in emulsifying the oil component into the water component and to impart thermal stability. The stabilizers are optionally added to maintain the stability of the oil-in-water emulsion.

Additional preferred, but optional, ingredients include enhancing ingredients that also may be added to the mixture. The enhancing ingredients are added to enhance the flavor, texture, or appearance of the base. However, the enhancing ingredients are not necessary to produce the food sauce base of the present invention. A non-exhaustive list of enhancing ingredients that may optionally be added to the base of the present invention includes flavorants, such as lemon juice, lemon juice powder, reconstituted lemon juice, egg flavor, a lactic acid starter blend, a starter distillate, flavors, and salt; acidulants such as edible acids and edible acid anhydrides, including citric acid, hydrochloric acid, lactic acid, lemon juice powder; cheese; enzyme modified cheese; eggs; edible particulates such as bread crumbs, chopped nuts, meat, fruits, dried vegetables; herbs and seasonings; cordials and alcoholic beverages such as wine or beer; cocoa liquor; sweeteners such as sugar or corn syrup; artificial sweeteners; and starch. Additionally, colorants such as annatto, beta carotene, turmeric, FD&C dyes, and titanium dioxide may be optionally added to enhance the color of the sauce to be made from the heat stable oil-in-water emulsion of the present invention.

To prepare the one embodiment of a heat stable oil-in-water emulsion, the aqueous component, preferably cream, is heated to between about a temperature sufficient to make the fat fluid, typically about 104° F., while being agitated. Preferably the cream is heated to about between about 130° F. and 140° F. The cream is heated with methods that do not add moisture to the cream such as but not limited to, a double boiler or a steam jacketed vessel. Water-soluble emulsifiers are optionally added to the aqueous component to promote temperature stability of the oil-in-water emulsion. The cream must be heated to a temperature sufficient to prevent whipping and churning when agitation is applied later in the process. A sufficient temperature for dairy cream is about 100° F.

With the cream heated to the selected temperature and sufficiently agitated, the solids component, preferably buttermilk powder, is gradually added to the cream such that the buttermilk powder is substantially uniformly dispersed in the cream. The buttermilk solids component contributes preferably between about 5 and 10 weight percent of the total weight of the oil-in-water emulsion.

With the buttermilk solids uniformly dispersed in the aqueous component, stabilizers such as, but not limited to, sodium benzoate and potassium sorbate are optionally added to the cream and buttermilk solids mixture.

The fat containing component, preferably anhydrous milk fat, is added to increase the volume and weight percent of the oil component and also to impart a creamier mouth-feel to the sauce made from the oil-in-water emulsion. If water-soluble emulsifiers are present in the aqueous component, fat-soluble emulsifiers may be optionally added to the fat containing component to promote temperature stability of the oil-in-water emulsion. If water-soluble emulsifiers are absent from the aqueous component, fat-soluble emulsifiers are necessary additions to the fat containing component. The anhydrous milk fat preferably contributes between about 5 and 20 weight percent of the total weight of the emulsion and preferably between about 10 and 15 weight percent of the total weight of the emulsion. The anhydrous milk fat is preferably heated to melt a sufficient amount of the fat containing component so that the fat containing component becomes fluid, such as to between about 110° F. and 170° F. and preferably to about 140° F. prior to being added to the mixture of cream and buttermilk solids. Preferably, the heated anhydrous milk fat is added to the mixture of cream and buttermilk solids under agitation to evenly disperse the anhydrous milk fat into the mixture of cream and buttermilk solids.

After the anhydrous milk fat is evenly dispersed into the mixture, colorants and flavorants are optionally added. Preferably, a starter distillate and an edible acid are added to the mixture for flavor. An exemplary starter distillate is Starter Distillate 3.0 manufactured by DairyChem Int'l. of Fishers, Ind. The starter distillate and the edible acid are added as flavorants.

The mixture of at least the cream, the buttermilk solids and the anhydrous milk fat is heated under agitation for a select period of time. Preferably the mixture is maintained at about 150° F. for about 20 minutes.

The mixture is then homogenized. Preferably the mixture is homogenized at between about 750 psig and 5000 psig through a single stage homogenizer. Homogenization with a multiple stage homogenizer is also within the scope of the present invention.

The mixture exiting the homogenizer is at a temperature of between about 110° F. and 150° F. and may be hot filled or rapidly cooled. An exemplary cooler is a scraped surface heat exchanger that cools the emulsion to a temperature range of between about 40° F. and 70° F. and preferably to a temperature range of 40° F. and 60° F. With the mixture cooled to the selected temperature, the oil-in-water emulsion has a consistency of a gravy.

The cooled dairy sauce is packaged into a desired container which is subsequently used by full service restaurants as a base for dairy based sauces. The cold filled dairy base is preferably stored under refrigeration to extend the shelf life.

Alternatively, the base can be packaged directly after being homogenized or hot filled at a temperature exiting the homogenizer preferably above 140° F. While the cold filled and hot filled dairy bases have the same compositions, the hot filled emulsion is thinner at elevated temperatures and thicker at refrigerated temperatures.

The restaurant uses the heat stable oil-in-water emulsion as a finished ready-to-use sauce, or as a base to make dairy based sauces such as, but not limited to, alfredo sauce and hollandaise sauce by adding additional ingredients as desired by the restaurant. However, unlike made from scratch sauces, the oil-in-water emulsion is heat stable and capable of being cycled from refrigerated temperatures to cooking temperatures and back without churning out or creaming. By using the heat stable oil-in-water emulsion as a base for the dairy based sauces requires the employees of the restaurant only to add the ingredients necessary to make the desired sauce and thereby eliminates the need to make the sauce from scratch and the risk of making an unsatisfactory sauce due to an unstable oil-in-water emulsion.

It has been discovered that the process of the present invention and the resulting products manufactured by the process are heat stable, being able to be cycled from a refrigerated temperature to a steam table and back without churning out at lower temperatures or creaming at elevated temperatures. Additionally, the dairy base can be stored in a refrigerated environment for a period of time and when used to produce a dairy based sauce provides the organoleptic properties of a freshly made sauce. The following Examples are illustrative only and are not intended to limit the present invention in any way.

### EXAMPLE 1

A base for a dairy based sauce was produced using the following formulation. This type of sauce is referred to in several ways, including but not limited to beurre blanc, butter sauce, or lemon butter upon addition of ingredients to this base which characterize the finished sauce.

TABLE 1

| | Approximate |
|---|---|
| Ingredient | Weight percent |
| Cream (40 weight % fat) | 77.01 |
| Buttermilk solids | 7.91 |
| Anhydrous milk fat | 12.32 |
| Emulsifier (Complemix 100) | 0.06 |
| Salt | 1.91 |
| Turmeric (color) | 0.008 |
| Sodium benzoate | 0.05 |
| Potassium sorbate | 0.05 |
| Starter distillate | 0.33 |
| Lactic acid | 0.36 |
| | 100.00 |

The cream was heated to about 135° F. in a double boiler. The buttermilk powder was added to the heated cream under agitation. The emulsifier, sodium benzoate and potassium sorbate were also added to the mixture of buttermilk powder and cream under agitation. The emulsifier, Complemix 100, is manufactured by Cytec Industries, Inc. of West Paterson, N.J. Salt and turmeric were added after the emulsifiers and stabilizers were added to the mixture under agitation to form a first intermediate.

The anhydrous milk fat was heated in a separate container to about 140° F. such that the milk fat was at the approximate temperature of the cream and buttermilk powder solution. The heated anhydrous milk fat was added to the first intermediate under agitation to evenly disperse the milk fat into the cream and buttermilk thereby forming an intermediate. The starter distillate and lactic acid were added as flavorants to form the unprocessed base. The unprocessed base was heated to about 150° F. under agitation and maintained at 150° F. for about 30 minutes.

The unprocessed base was homogenized at about 750 psig through a single stage homogenizer. A heat stable oil-in-water emulsion exited the homogenizer at about 140° F. The heat stable oil-in-water emulsion was rapidly cooled with a scraped surface heat exchanger (SSHE) to about 40° F.

The heat stable oil-in-water emulsion had about 43.6 weight percent milk fat, 43.1 weight percent moisture, about 4.3 weight percent protein, about 6.0 weight percent lactose and about 3.0 weight percent salt and ash. The base included 23.6 weight percent solids non-fat calculated with the disclosed formula. The heat stable oil-in-water emulsion was found to be repeatedly cyclable from refrigerated temperature to cooking temperatures and back to the refrigerated temperature without churning out or creaming. In addition, the heat stable oil-in-water emulsion demonstrated excellent freeze-thaw stability even when stored frozen at 25° F. for two weeks.

### EXAMPLE 2

An oil-in-water emulsion for use as a base for a dairy based sauce was produced using the following formulation. This type of sauce is referred to in several ways, including but not limited to beurre blanc, butter sauce, or lemon butter.

TABLE 2

| | Approximate |
|---|---|
| Ingredient | Weight percent |
| Cream (40 weight % fat) | 80.95 |
| Buttermilk solids | 6.75 |
| Anhydrous milk fat | 10.01 |
| Emulsifier (Complemix 100) | 0.06 |
| Lecithin | 0.06 |
| Salt | 1.92 |
| Turmeric (color) | 0.02 |
| Starter distillate | 0.23 |
| | 100.00 |

The oil-in-water emulsion was produced using the procedure disclosed in Example 1. The heat stable oil-in-water emulsion had about 42.77 weight percent milk fat, 45.29 weight percent moisture, about 3.98 weight percent protein, about 5.57 weight percent lactose and about 2.81 weight percent salt and ash. The base included 21.44 weight percent solids non-fat calculated with the disclosed formula. The heat stable oil-in-water emulsion was found to be repeatedly cyclable from refrigerated temperature to cooking temperatures and back to the refrigerated temperature without churning out or creaming. In addition, the heat stable oil-in-water emulsion demonstrated excellent freeze-thaw stability even when stored frozen at 25° F. for two weeks.

### EXAMPLE 3

An oil-in-water emulsion for use as a base for a dairy based sauce was produced using the following formulation. This type of sauce is referred to in several ways, including but not limited to beurre blanc, butter sauce, or lemon butter.

TABLE 3

| | Approximate |
|---|---|
| Ingredient | Weight percent |
| Cream (40 weight % fat) | 76.13 |
| Buttermilk solids | 4.92 |
| Anhydrous milk fat | 15.40 |
| Emulsifier (Complemix 100) | 0.06 |
| Salt | 1.80 |
| Starter distillate | 0.19 |
| Sodium benzoate | 0.75 |
| Potassium sorbate | 0.75 |
| | 100.00 |

The oil-in-water emulsion was produced using the following procedure. Anhydrous milk fat was melted, heated to approximately 140° F., then emulsifier was added and mixed to disperse it within the fat phase. Buttermilk solids were added to the cream in a separate vessel along with salt, and preservatives. The cream mixture was heated in a double boiler to approximately 150° F. then the fat phase was added to the cream with sufficient mechanical agitation to disperse the fat into the cream phase. Flavorant was added then the complete mixture was heated to pasteurization temperatures (155-165° F.) and held for 30 minutes. After pasteurization the mixture was homogenized and rapidly cooled for storage. The heat stable oil-in-water emulsion was found to be repeatedly cyclable from refrigerated temperature to cooking temperatures and back to the refrigerated temperature without churning out or creaming. In addition, the heat stable oil-in-water emulsion demonstrated excellent freeze-thaw stability even when stored frozen at 25° F. for two weeks.

### EXAMPLE 4

An alfredo sauce was produced from the heat stable oil-in-water base of the present invention. The base was produced with the following formulation.

TABLE 4

| | Approximate |
|---|---|
| Ingredient | Weight percent |
| Cream (40 weight % fat) | 76.95 |
| Buttermilk solids | 7.94 |
| Anhydrous milk fat | 12.36 |
| Emulsifier (Complemix 100) | 0.06 |
| Salt | 1.56 |
| Sodium benzoate | 0.10 |
| Potassium sorbate | 0.75 |
| Starter distillate | 0.28 |
| | 100.00 |

The oil-in-water emulsion was produced using essentially the same procedure as disclosed in Example 3 with a few modifications. One modification was the emulsion was only slightly cooled after homogenization instead of being cooled to between about 40° F. and 60° F. Additionally, because the alfredo sauce has a white color, no colorant was added to the base. The heat stable oil-in-water emulsion had about 43.75 weight percent milk fat, 43.32 weight percent moisture, about 4.31 weight percent protein, about 6.06 weight percent lactose and about 2.99 weight percent salt and ash. The base included 23.57 weight percent solids non-fat calculated with the disclosed formula.

Upon exiting the homogenizer, the oil-in-water emulsion was slightly cooled and a range of between about 10 weight percent and about 25 weight percent shredded parmesan cheese and preferably about 17.62 weight percent shredded parmesan cheese was added to the oil-in-water emulsion based upon the weight of the alfredo sauce. When the parmesan cheese was melted into the emulsion and evenly dispersed therethrough, the alfredo sauce was packaged and stored in a refrigerated cooler. With the parmesan cheese mixed into the base, the alfredo sauce was heat stable and having the organoleptic properties of a made from scratch alfredo sauce. In addition, the alfredo sauce demonstrated excellent freeze-thaw stability even when stored frozen at 25° F. for two weeks.

### EXAMPLE 5

An alfredo sauce was produced from the heat stable oil-in-water base of the present invention. The base was produced with the following formulation.

TABLE 5

| | Approximate |
|---|---|
| Ingredient | Weight percent |
| Cream (40 weight % fat) | 75.67 |
| Buttermilk solids | 7.93 |
| Anhydrous milk fat | 12.20 |
| Polysorbate 60 | 0.093 |
| Lecithin | 0.093 |
| Salt | 1.88 |
| Sodium benzoate | 0.066 |
| Potassium sorbate | 0.066 |
| Starter distillate | 0.33 |
| | 100.00 |

The oil-in-water emulsion was produced using essentially the same procedure disclosed in Example 3. However because an alfredo sauce, which is often white in color, was being produced, no colorant was added to the base. The heat stable oil-in-water emulsion had about 43.59 weight-percent milk fat, 44.37 weight percent moisture, about 4.30 weight percent protein, about 6.04 weight percent lactose and about 3.00 weight percent salt and ash. The base included 23.11 weight percent solids non-fat calculated with the disclosed formula.

The base was heated to about 140° F. and was agitated while heated and additional ingredients were added. A parmesan/romano flavorant manufactured by First Choice Ingredients located at Germantown, Wis. was added such that the flavorant contributed preferably about 4.0 weight percent to the total weight of the alfredo sauce. However, the flavorant may be added in the range of between 0 and 7 weight percent of the alfredo sauce while being within the scope of the present invention. Shredded parmesan cheese was added to the agitated base such that the parmesan cheese contributed in the range of 10 weight percent and 25 weight percent and preferably 16.0 weight percent of the total weight of the alfredo sauce. With the flavorant and parmesan cheese mixed into the base, the alfredo sauce was heat stable and having the organoleptic properties of a made from scratch alfredo sauce In addition, the alfredo sauce demonstrated excellent freeze-thaw stability even when stored frozen at 25° F. for two weeks.

### EXAMPLE 6

A hollandaise sauce was produced from the heat stable oil-in-water base of the present invention. The base was produced with the following formulation.

TABLE 6

| | Approximate |
|---|---|
| Ingredient | Weight percent |
| Cream (40 weight % fat) | 77.92 |
| Buttermilk solids | 8.09 |
| Anhydrous milk fat | 12.49 |
| Emulsifier (Complemix 100) | 0.06 |
| Salt | 1.01 |
| Sodium benzoate | 0.10 |
| Potassium sorbate | 0.125 |
| Starter distillate | 0.205 |
| | 100.00 |

The oil-in-water emulsion was produced using a procedure essentially the same as the procedure disclosed in Example 3. Additionally, no colorant was added to the base. After heating the mixture to 150° F. for 20 minutes the lemon juice was added and the mixture was homogenized and rapidly cooled. One skilled in the art will recognize that a range of weight percent lemon juice may be used to may the hollandaise sauce of the present invention ranging from between about 3 weight percent to 15 weight percent of the hollandaise sauce.

The heat stable oil-in-water emulsion without lemon juice had about 44.12 weight percent milk fat, 43.64 weight percent moisture, about 4.37 weight percent protein, about 6.15 weight percent lactose and about 2.10 weight percent salt and ash. The base included 29.54 weight percent solids non-fat calculated with the disclosed formula.

The Hollandaise sauce had the organoleptic properties of a made from scratch hollandaise sauce, but unlike most Hollandaise sauce was heat stable and able to be cycled from refrigerated temperatures to cooking temperatures and back without churning out or creaming. In addition, the Hollandaise sauce demonstrated excellent freeze-thaw stability even when stored frozen at 25° F. for two weeks.

### EXAMPLE 7

Three hollandaise sauces were produced from the heat stable oil-in-water base of the present invention. The base was produced with the following formulation.

TABLE 7

| | Approximate |
|---|---|
| Ingredient | Weight percent |
| Cream (40 weight % fat) | 57.26 |
| Salted butter | 12.56 |
| Buttermilk solids | 7.92 |
| Anhydrous milk fat | 12.19 |
| Emulsifier (Complemix 100) | 0.07 |
| Color (Tumeric) | 0.009 |
| Reconstituted lemon juice | 7.80 |
| Salt | 1.75 |
| Sodium benzoate | 0.06 |
| Potassium sorbate | 0.06 |
| Starter distillate | 0.32 |
| | 100.00 |

Each oil-in-water emulsion was produced using a procedure similar to the procedure disclosed in Example 3. After heating the mixture to 150° F. for 20 minutes lemon juice was added in a concentration of 9.27 weight percent of the end product and the mixture was homogenized. Lemon juice may be added in the range of between 3 and 12 weight percent of the total weight of the sauce. One sample was rapidly cooled using the procedure described in Example 1, the second sample was slowly cooled and the third sample was hot packed without cooling.

The heat stable oil-in-water emulsion had about 48.72 weight percent milk fat, 38.48 weight percent moisture, about 4.16 weight percent protein, about 5.71 weight percent lactose and about 2.50 weight percent salt and ash. The base included 24.33 weight percent solids non-fat calculated with the disclosed formula.

The rapidly cooled sample was pourable at refrigerator temperatures while the slow cooled sample was thicker and spoonable.

At 150° F., the rapidly cooled sample was thicker than the slow cooled sample and the hot packed sample was too thin to be acceptable. The rapidly cooled sample and the slowly cooled sample were cooled and reheated. Upon being reheated, the emulsion of the slowly cooled sample became unstable while the rapidly cooled sample maintained a stable emulsion. Therefore, the experiment indicates that rapid cooling after exiting the homogenizer makes the emulsion more stable when subjected to temperature cycling and also more easily used at refrigerated temperatures.

The Hollandaise sauce had the organoleptic properties of a made from scratch hollandaise sauce, but unlike most Hollandaise sauce was heat stable and able to be cycled from refrigerated temperatures to cooking temperatures and back without churning out or creaming. In addition, the Hollandaise sauce demonstrated excellent freeze-thaw stability even when stored frozen at 25° F. for two weeks.

### EXAMPLE 8

A hollandaise sauce was produced from the heat stable oil-in-water base of the present invention. The hollandaise sauce was produced with the following formulation.

TABLE 8

| | Approximate |
|---|---|
| Ingredients | Weight percent |
| Cream (40 weight % fat) | 60.55 |
| Salted butter | 11.71 |
| Buttermilk solids | 7.15 |
| Anhydrous milk fat | 11.00 |
| Polysorbate 60 | 0.09 |
| Lecithin | 0.08 |
| Starch | 1.25 |
| Salt | 1.30 |
| Beta carotene | 0.002 |
| Annatto | 0.016 |
| Sodium benzoate | 0.05 |
| Potassium sorbate | 0.125 |
| Starter distillate | 0.32 |
| Egg flavor | 0.065 |
| Lemon juice powder | 0.090 |
| Water | 6.07 |
| Citric acid | 0.132 |
| | 100.00 |

The cream, water and butter were heated to about 135° F. in a double boiler. The buttermilk powder and the lemon juice powder were added to the heated cream under agitation. The lemon juice powder may be added in the range of 0.03 to 0.15 weight percent of the weight of the hollandaise sauce. The lecithin, sodium benzoate, Polysorbate 60, starch and potassium sorbate were also added to the mixture of buttermilk powder and cream under agitation. Salt and turmeric were added after the emulsifiers and stabilizers were added to the mixture under agitation to form a first intermediate.

The anhydrous milk fat and butter were heated in separate containers to about 140° F. such that the milk fat was at the approximate temperature of the cream and buttermilk powder solution. The heated anhydrous milk fat was added to the first intermediate under agitation to evenly disperse the milk fat into the cream and buttermilk thereby forming an intermediate. The starter distillate and lactic acid were added as flavorants to form the unprocessed base. The unprocessed base was heated to about 150° F. and maintained at 150° F. for about 20 minutes.

The beta carotene, annatto, egg flavor and citric acid were added to the unprocessed base to add color and flavor. The unprocessed base was homogenized at about 750 psig through single stage homogenizer. A heat stable oil-in-water emulsion exited the homogenizer at about 140° F. The heat stable hollandaise sauce was rapidly cooled with a scraped surface heat exchanger (SSHE) to about 40° F.

The heat stable hollandaise sauce had about 44.68 weight percent milk fat, 39.56 weight percent moisture, about 3.77 weight percent protein, about 5.18 weight percent lactose and about 2.68 weight percent salt and ash. The sauce included 22.72 weight percent solids non-fat calculated with the disclosed formula.

The Hollandaise sauce had the organoleptic properties of a made from scratch hollandaise sauce, but unlike most Hollandaise sauce was heat stable and able to be cycled from refrigerated temperatures to cooking temperatures and back without churning out or creaming. In addition, the Hollandaise sauce demonstrated excellent freeze-thaw stability even when stored frozen at 25° F. for two weeks.

### EXAMPLE 9

A lower-cost version of simulated hollandaise sauce was prepared.

TABLE 9

| | Approximate |
|---|---|
| Ingredient | Weight percent |
| Soybean oil | 28.42 |
| Buttermilk powder (dry) | 13.50 |
| Salt | 1.25 |
| Beta carotene | 0.0022 |
| Annatto | 0.0164 |
| Sodium benzoate | 0.10 |
| Potassium sorbate | 0.125 |
| Starter distillate | 0.50 |
| CMB flavor | 0.008 |
| Polysorbate 60 | 0.09 |
| Lecithin | 0.075 |
| Egg flavor | 0.058 |
| Lemon juice powder | 0.65 |
| Water | 55.20 |
| Citric acid | 0.01 |
| | 100.00 |

A first intermediate was made by dissolving salt and buttermilk in water. Emulsifiers (Polysorbate 60, lecithin) were dissolved in the fat containing component (soybean oil). The fat containing component was dispersed into the aqueous component with sufficient mixing to develop a second intermediate. Flavorants (egg flavor, CMB flavor, lemon juice powder, citric acid), colors (beta-carotene, annatto) and preservatives (sodium benzoate, potassium sorbate) were added to the second intermediate and the second intermediate was homogenized.

The simulated Hollandaise sauce had the organoleptic properties of a made from scratch hollandaise sauce, but unlike most Hollandaise sauce was heat stable and able to be cycled from refrigerated temperatures to cooking temperatures and back without churning out or creaming. In addition, the Hollandaise sauce demonstrated excellent freeze-thaw stability even when stored frozen at 25° F. for two weeks.

### EXAMPLE 10

A reduced heavy cream sauce was produced using the following formulation.

TABLE 10

| | Approximate |
|---|---|
| Ingredient | Weight percent |
| Cream (40 weight % fat) | 78.88 |
| Buttermilk powder | 8.22 |
| Anhydrous milk fat | 12.65 |
| Polysorbate 60 | 0.075 |
| Lecithin | 0.075 |
| Sodium benzoate | 0.05 |
| Potassium sorbate | 0.05 |
| | 100.00 |

The oil-in-water emulsion was produced using the procedure disclosed in Example 3. The heat stable oil-in-water emulsion had about 44.67 weight percent milk fat, 44.18 weight percent moisture, about 4.44 weight percent protein, about 6.23 weight percent lactose and about 0.75 weight percent salt and ash. The base included 26.54 weight percent solids non-fat calculated with the disclosed formula.

The reduced heavy cream sauce had the organoleptic properties of a made from scratch reduced heavy cream sauce, but unlike most reduced heavy cream sauces, was heat stable and able to be cycled from refrigerated temperatures to cooking temperatures and back without churning out or creaming. In addition, the reduced heavy cream sauce demonstrated excellent freeze-thaw stability even when stored frozen at 25° F. for two weeks.

### EXAMPLE 11

A butter sauce base was prepared by the process outlined in example 3, with pH adjustment.

TABLE 11

| | Approximate |
|---|---|
| Ingredient | Weight percent |
| Cream (40% fat) | 77.219 |
| Buttermilk powder (dry) | 7.85 |
| Polysorbate 60 | 0.075 |
| Lecithin | 0.075 |
| Salt | 1.905 |
| Color (Turmeric) | 0.004 |
| Beta carotene | 0.001 |
| Sodium Benzoate | 0.05 |
| Potassium Sorbate | 0.050 |
| Starter Distillate | 0.331 |
| Anhydrous milkfat | 12.364 |
| | 100.00 |
| Citric acid | variable* |

*Citric acid was used to adjust pH to 5.5 ± 0.2

The butter sauce base had the organoleptic properties of a made from scratch butter sauce but unlike most butter sauce bases, was heat stable and able to be cycled from refrigerated temperatures to cooking temperatures and back without churning out or creaming. In addition, the butter sauce base demonstrated excellent freeze-thaw stability even when stored frozen at 25° F. for two weeks.

### EXAMPLE 12

A butter sauce was made according to the process outlined in example 3, except that homogenization was carried out at 4000 psig.

TABLE 12

| | Approximate |
|---|---|
| Ingredient | Weight percent |
| Cream (40% fat) | 17.46 |
| Whey protein concentrate | 4.31 |
| Water | 27.34 |
| Polysorbate 60 | 0.08 |
| Lecithin Yelkin TS | 0.08 |
| Salt | 0.58 |
| Color (Turmeric) | 0.0025 |
| Beta-Carotene | 0.0027 |
| Sodium benzoate | 0.10 |
| Starter distillate | 0.25 |
| Salted butter | 49.66 |
| Water | 0.135 |
| | 100.00 |

The butter sauce base had the organoleptic properties of a made from scratch butter sauce but unlike most butter sauce bases, was heat stable and able to be cycled from refrigerated temperatures to cooking temperatures and back without churning out or creaming. In addition, the butter sauce base demonstrated excellent freeze-thaw stability even when stored frozen at 25° F. for two weeks.

### EXAMPLE 13

A butter sauce was made according to the process outlined in example 3, except that soy protein was used.

TABLE 13

| | Approximate |
|---|---|
| Ingredient | Weight percent |
| Cream (40% fat) | 19.44 |
| Soy protein * | 1.00 |
| Water | 23.12 |
| Polysorbate 60 | 0.08 |
| Lecithin Yelkin TS | 0.08 |
| Salt | 0.65 |
| Color (Turmeric) | 0.002 |
| Beta Carotene | 0.0013 |
| Sodium benzoate | 0.05 |
| Potassium sorbate | 0.125 |
| Starter distillate | 0.33 |
| Salted butter | 55.10 |
| | 100.00 |

* Soy protein was Alpha proteo 5800 soy protein concentrate from Central Soya, Ft. Wayne, IN.

The butter sauce base had the organoleptic properties of a made from scratch butter sauce but unlike most butter sauce bases, was heat stable and able to be cycled from refrigerated temperatures to cooking temperatures and back without churning out or creaming. In addition, the butter sauce base demonstrated excellent freeze-thaw stability even when stored frozen at 25° F. for two weeks.

Although the present invention has been described with reference to preferred embodiments, workers skilled in the art will recognize that changes may be made in form and detail without departing from the spirit and scope of the invention.

1. A method of forming a heat stable oil-in-water emulsion comprising:
providing a selected amount of an aqueous component;
heating the aqueous component to a temperature sufficient to avoid whipping and churning of the aqueous component when shear is applied;
adding a selected amount of a solids component to the aqueous component under agitation to form a first intermediate;
heating a selected amount of a fat containing component to a temperature sufficient to melt a sufficient amount of the fat containing component so that the fat containing component becomes fluid;
adding an emulsifier either to the aqueous component or to the fat containing component or both;
adding the heated fat containing component to the first intermediate with sufficient agitation to disperse the added fat containing component in the first intermediate to form a second intermediate;
homogenizing the second intermediate at between about 250 psig and 5000 psig to form the heat stable oil-in-water emulsion comprising at least 20 weight percent fat.

2. The method of claim 1 and wherein the fat is heated to between about 100° F. and 150° F.

3. The method of claim 1 and wherein the second intermediate is heated for a selected period of time

4. The method of claim 3 and wherein the second intermediate is homogenized at a temperature sufficient to maintain the fat containing component in a fluid condition.

5. The method of claim 4 and wherein the second intermediate is pasteurized.

6. The method of claim 1 wherein the aqueous component comprises a cream.

7. The method of claim 1 and wherein the aqueous component comprises about 40 weight percent fat.

8. The method of claim 1 and wherein the solids component comprises buttermilk solids.

9. The method of claim 8 and wherein the selected amount of buttermilk solids component is between about 3 and 10 weight percent of the heat stable oil-in-water emulsion.

10. The method of claim 1 and wherein the solids component comprises whey solids.

11. The method of claim 10 and wherein the selected amount of whey solids component is between about 3 and 10 weight percent of the heat stable oil-in-water emulsion.

12. The method of claim 1 and wherein the solids component comprises soy protein solids.

13. The method of claim 12 and wherein the selected amount of soy protein solids component is between about 0.5 and 10 weight percent of the heat stable oil-in-water emulsion.

14. The method of claim 1 and wherein the fat containing component comprises milk fat.

15. The method of claim 1 and wherein the fat containing component comprises vegetable oil.

16. The method of claim 1 and wherein the fat containing component comprises milk fat and vegetable oil in combination.

17. The method of claim 1 and wherein the fat containing component comprises anhydrous milk fat.

18. The method of claim 17 and wherein the selected amount of anhydrous milk fat is an amount sufficient to provide a heat-stable oil-in-water emulsion comprising at least about 20% fat.

19. The method of claim 17 and wherein the selected amount of anhydrous milk fat is an amount sufficient to provide a heat-stable oil-in-water emulsion comprising at least about 40% fat.

20. The method of claim 1 and wherein the fat containing component comprises butter.

21. The method of claim 20 and wherein the selected amount of butter is above about 5 weight percent.

22. The method of claim 1 and wherein the fat containing component comprises vegetable oil.

23. The method of claim 22 and wherein the selected amount of vegetable oil is above about 5 weight percent

24. The method of claim 1 and further comprising adding stabilizers to the heated aqueous component.

25. The method of claim 1 and further comprising adding enhancing ingredients to the aqueous component.

26. The method of claim 1 and further comprising adding enhancing ingredients to the fat containing component.

27. The method of claim 1 and further comprising adding enhancing ingredients to the first intermediate

28. The method of claim 1 and further comprising adding enhancing ingredients to the second intermediate.

29. The method of claim 1 and further comprising adding enhancing ingredients to the finished heat stable oil-in-water emulsion.

30. The method of claim 1 and further comprising cooling the stable oil-in-water emulsion to between about 30° F. and 70° F.

31. The method of claim 1 and further comprising hot filling the heat stable oil-in-water emulsion at a temperature of about 170° F. and about 210° F.

32. The method of claim 1 and further comprising adding a selected amount of cheese to the oil-in-water emulsion to form a dairy-based cheese sauce.

33. The method of claim 1 and further comprising adding a selected amount of cheese to the oil-in-water emulsion to form an alfredo sauce.

34. The method of claim 33 and wherein the selected amount of cheese is between about 10 and 25 weight percent of the alfredo sauce.

35. The method of claim 1 and further comprising adding a selected amount of lemon juice and a selected amount of egg yolk or egg flavor to the oil-in-water emulsion to form a hollandaise sauce.

36. The method of claim 1 and further comprising adding a selected amount of citric acid to the oil-in-water emulsion to form a hollandaise sauce.

37. The method of claim 35 and further comprising adding a selected amount of citric acid to the oil-in-water emulsion to form a hollandaise sauce.

38. The method of claim 35 and wherein the selected amount of lemon juice is between about 3.0 and 12.0 weight percent of the hollandaise sauce.

39. The method of claim 37 and wherein the selected amount of lemon juice is between about 3.0 and 12.0 weight percent of the hollandaise sauce.

40. The method of claim 1 and further comprising adding butter to form a butter sauce.

41. A method of forming a heat stable dairy based sauce comprising:
providing a selected amount of an aqueous component;
heating the aqueous component to a temperature sufficient to avoid whipping and churning of the aqueous component when shear is applied;
adding a selected amount of a solids component to the aqueous component under agitation to form a first intermediate;
heating a selected amount of a milk fat containing component to a temperature sufficient to melt a sufficient amount of the fat containing component so that the fat containing component becomes fluid;
adding an emulsifier either to the aqueous component or to the milk fat containing component or both;
adding the heated milk fat containing component to the first intermediate with sufficient agitation to disperse the added fat containing component in the first intermediate to form a second intermediate;
homogenizing the second intermediate at between about 250 psig and 5000 psig to form the heat stable oil-in-water emulsion comprising at least 20 weight percent fat.

42. The method of claim 41 and wherein the fat is heated to between about 100° F. and 150° F.

43. The method of claim 41 and wherein the second intermediate is heated for a selected period of time

44. The method of claim 43 and wherein the second intermediate is homogenized at a temperature sufficient to maintain the fat containing component in a fluid condition.

45. The method of claim 43 and wherein the second intermediate is pasteurized.

46. The method of claim 41 and wherein the aqueous component comprises a dairy cream.

47. The method of claim 41 and wherein the aqueous component comprises about 40 weight percent milk fat.

48. The method of claim 41 and wherein the solids component comprises buttermilk solids.

49. The method of claim 48 and wherein the selected amount of buttermilk solids component is between about 3 and 10 weight percent of the heat stable oil-in-water emulsion.

50. The method of claim 41 and wherein the solids component comprises whey solids.

51. The method of claim 50 and wherein the selected amount of whey solids component is between about 3 and 10 weight percent of the heat stable oil-in-water emulsion.

52. The method of claim 41 and wherein the solids component comprises soy protein solids.

53. The method of claim 52 and wherein the selected amount of soy protein solids component is between about 0.5 and 10 weight percent of the heat stable oil-in-water emulsion.

54. The method of claim 41 and wherein the milk fat containing component comprises anhydrous milk fat.

55. The method of claim 54 and wherein the selected amount of anhydrous milk fat is an amount sufficient to provide a heat-stable oil-in-water emulsion comprising at least about 20% fat.

56. The method of claim 54 and wherein the selected amount of anhydrous milk fat is an amount sufficient to provide a heat-stable oil-in-water emulsion comprising at least about 40% fat.

57. The method of claim 41 and wherein the milk fat containing component comprises butter.

58. The method of claim 57 and wherein the selected amount of butter is above about 5 weight percent.

59. The method of claim 41 and further comprising adding stabilizers to the heated aqueous component.

60. The method of claim 41 and further comprising adding enhancing ingredients to the aqueous component.

61. The method of claim 41 and further comprising adding enhancing ingredients to the milk fat containing component.

62. The method of claim 41 and further comprising adding enhancing ingredients to the first intermediate

63. The method of claim 41 and further comprising adding enhancing ingredients to the second intermediate.

64. The method of claim 41 and further comprising adding enhancing ingredients to the finished heat stable oil-in-water emulsion.

65. The method of claim 41 and further comprising cooling the stable oil-in-water emulsion to between about 30° F. and 70° F.

66. The method of claim 41 and further comprising hot filling the heat stable oil-in-water emulsion at a temperature of about 170° F. and about 210° F.

67. The method of claim 41 and further comprising adding a selected amount of cheese to the oil-in-water emulsion to form a cheese sauce.

68. The method of claim 41 and further comprising adding a selected amount of cheese to the oil-in-water emulsion to form an alfredo sauce.

69. The method of claim 68 and wherein the selected amount of cheese is between about 10 and 25 weight percent of the alfredo sauce.

70. The method of claim 41 and further comprising adding a selected amount of lemon juice and a selected amount of egg yolk or egg flavor to the oil-in-water emulsion to form a hollandaise sauce.

71. The method of claim 41 and further comprising adding a selected amount of citric acid to the oil-in-water emulsion to form a hollandaise sauce.

72. The method of claim 71 and further comprising adding a selected amount of citric acid to the oil-in-water emulsion to form a hollandaise sauce.

73. The method of claim 71 and wherein the selected amount of lemon juice is between about 3.0 and 12.0 weight percent of the hollandaise sauce.

74. The method of claim 72 and wherein the selected amount of lemon juice is between about 3.0 and 12.0 weight percent of the hollandaise sauce.

75. The method of claim 41 and further comprising adding butter to form a butter sauce.

76. The method of 41 and wherein the aqueous component is cultured.

77. A sauce base, the sauce base comprising:
an aqueous component wherein the aqueous component comprises more than 50 weight percent moisture;
a solids component wherein the solids component comprises protein; and
a fat containing component wherein the fat containing component increases a fat concentration of the base to greater than 20 weight percent;
an emulsifier wherein the emulsifier is added to the aqueous component or to the milk fat containing component or both and wherein the aqueous component, the solids component the fat containing component and the emulsifier are added together such that the protein concentration of the base is in a range of greater than 3 weight percent and less than 10 weight percent and wherein when the base is homogenized and packaged, the base comprises an oil-in-water emulsion that is storable, heat stable and usable for a dairy based sauce having the organoleptic properties of a made from scratch dairy based sauce.

78. The sauce base of claim 77 and wherein the fat is heated to between about 100° F. and 150° F.

79. The sauce base of claim 77 and wherein the second intermediate is heated for a selected period of time

80. The sauce base of claim 79 and wherein the second intermediate is homogenized at a temperature sufficient to maintain the fat containing component in a fluid condition.

81. The sauce base of claim 80 and wherein the second intermediate is pasteurized.

82. The base of claim 77 and wherein the base comprises an oil-in-water emulsion that is storable.

83. The base of claim 77 and wherein the base comprises an oil-in-water emulsion that is heat stable.

84. The base of claim 77 and wherein the base comprises an oil-in-water emulsion that is freeze-thaw stable.

85. The base of claim 77 and wherein the base comprises an oil-in-water emulsion that is freeze-thaw stable.

86. The base of claim 77 and wherein a fat concentration of the base comprises between about 20 weight percent and 96 weight percent of the base.

87. The base of claim 77 and wherein a moisture concentration of the base comprises between about 35 weight percent and 50 weight percent of the base.

88. The base of claim 77 and wherein a solids non-fat content of the base is greater than three weight percent and less than or equal to 30 weight percent of the base.

89. The base of claim 77 and wherein the aqueous component comprises a cream.

90. The base of claim 89 and wherein the cream comprises about 40 weight percent fat.

91. The base of claim 77 and wherein the solids component comprises buttermilk solids.

92. The base of claim 91 and wherein the buttermilk solids comprise between about 3 weight percent and 10 weight percent.

93. The base of claim 77 and wherein the solids component comprises whey solids.

94. The base of claim 93 and wherein the selected amount of whey solids component is between about 3 and 10 weight percent of the heat stable oil-in-water emulsion.

95. The base of claim 77 and wherein the solids component comprises soy protein solids.

96. The base of claim 95 and wherein the selected amount of soy protein solids component is between about 0.5 and 10 weight percent of the heat stable oil-in-water emulsion.

97. The base of claim 77 and wherein the fat containing component comprises vegetable oil.

98. The base of claim 97 and wherein the vegetable oil comprises above about 5 weight percent of the total weight of the base.

99. The base of claim 99 and wherein the fat containing component further comprises butter.

100. The base of claim 99 and wherein the sum of the vegetable oil and the butter comprises above about 5 weight percent of the total weight of the base.

101. The base of claim 77 and further comprising stabilizers.

102. The base of claim 77 and further comprising enhancing ingredients.

103. The base of claim 77 and further comprising enhancing ingredients added to the aqueous component.

104. The base of claim 77 and further comprising enhancing ingredients added to the fat containing component.

105. The base of claim 77 and further comprising enhancing ingredients added to the first intermediate

106. The base of claim 77 and further comprising enhancing ingredients added to the second intermediate.

107. The base of claim 77 and further comprising enhancing ingredients added to the finished heat stable oil-in-water emulsion.

108. The base of claim 77 and further comprising cooling the oil-in-water emulsion with a scraped surface heat exchanger.

109. The base of claim 77 and further comprising cheese and wherein the cheese forms the base into an alfredo sauce.

110. The base of claim 109 and wherein the cheese comprises between about 10 weight percent and 25 weight percent of the weight of the alfredo sauce.

111. The base of claim 77 and further comprising lemon juice and egg flavor or egg yolk and wherein the lemon juice and egg flavor or egg yolk forms the base into a hollandaise sauce.

112. The base of claim 111 and wherein the lemon juice comprises between about 3 and 12 weight percent of the weight of the hollandaise sauce.

113. The base of claim 77 and further comprising lemon juice powder and egg flavor or egg yolk and wherein the lemon juice powder and egg flavor or egg yolk transforms the base into a hollandaise sauce.

114. The base of claim 113 and wherein the lemon juice powder comprises between about 0.03 and 0.15 weight percent of the weight of the hollandaise sauce.

115. A dairy sauce base, the dairy sauce base comprising:
an aqueous dairy cream component;
a solids component wherein the solids component comprises protein; and
a milk fat containing component wherein the milk fat containing component increases a milk fat concentration of the base to greater than 20 weight percent;
an emulsifier wherein the emulsifier is added to the aqueous component or to the milk fat containing component or both and wherein the aqueous component, the solids component and the milk fat containing component are added together such that the protein concentration of the base is in a range of greater than 3 weight percent and less than 10 weight percent and wherein when the base is homogenized and packaged, the base comprises an oil-in-water emulsion that is usable for a dairy based sauce having the organoleptic properties of a made from scratch dairy based sauce.

116. The base of claim 115 and wherein the base comprises an oil-in-water emulsion that is storable.

117. The base of claim 116 and wherein the base comprises an oil-in-water emulsion that is heat stable.

118. The base of claim 116 and wherein the base comprises an oil-in-water emulsion that is freeze-thaw stable.

119. The base of claim 117 and wherein the base comprises an oil-in-water emulsion that is freeze-thaw stable.

120. The base of claim 115 and wherein a milk fat concentration of the base comprises between about 20 weight percent and 96 weight percent of the base.

121. The base of claim 115 and wherein a moisture concentration of the base comprises between about 35 weight percent and 50 weight percent of the base.

122. The base of claim 115 and wherein a solids non-fat content of the base is greater than three weight percent and less than or equal to 30 weight percent of the base.

123. The base of claim 115 and wherein the aqueous component comprises cream.

124. The base of claim 123 and wherein the cream comprises about 40 weight percent milk fat.

125. The base of claim 115 and wherein the solids component comprises buttermilk solids.

126. The base of claim 125 and wherein the buttermilk solids comprise between about 3 weight percent and 10 weight percent.

127. The method of claim 115 and wherein the solids component comprises whey solids.

128. The method of claim 127 and wherein the selected amount of whey solids component is between about 3 and 10 weight percent of the heat stable oil-in-water emulsion.

129. The method of claim 115 and wherein the solids component comprises soy protein solids.

130. The method of claim 129 and wherein the selected amount of soy protein solids component is between about 0.5 and 10 weight percent of the heat stable oil-in-water emulsion.

131. The base of claim 115 and wherein the milk fat containing component comprises anhydrous milk fat.

132. The base of claim 131 and wherein the anhydrous milk fat comprises above about 5 weight percent of the total weight of the base.

133. The base of claim 115 and wherein the milk fat containing component comprises butter.

134. The base of claim 133 and wherein the butter comprises above about 5 weight percent of the total weight of the base.

135. The base of claim 115 and further comprising stabilizers.

136. The base of claim 115 and further comprising enhancing agents.

137. The base of claim 115 and further comprising enhancing ingredients added to the aqueous component.

138. The base of claim 115 and further comprising enhancing ingredients added to the fat containing component.

139. The base of claim 115 and further comprising enhancing ingredients added to the first intermediate

140. The base of claim 115 and further comprising enhancing ingredients added to the second intermediate.

141. The base of claim 115 and further comprising enhancing ingredients added to the finished heat stable oil-in-water emulsion.

142. The base of claim 115 and further comprising cooling the oil-in-water emulsion with a scraped surface heat exchanger.

143. The base of claim 115 and further comprising cheese and wherein the cheese forms the base into an alfredo sauce.

144. The base of claim 143 and wherein the cheese comprises between about 10 weight percent and 25 weight percent of the weight of the alfredo sauce.

145. The base of claim 115 and further comprising lemon juice and egg flavor or egg yolk and wherein the lemon juice and egg flavor or egg yolk forms the base into a hollandaise sauce.

146. The base of claim 145 wherein the lemon juice comprises between about 3 and 12 weight percent of the weight of the hollandaise sauce.

147. The base of claim 115 and further comprising lemon juice powder and egg flavor or egg yolk and wherein the lemon juice powder and egg flavor or egg yolk transforms the base into a hollandaise sauce.

148. The base of claim 147 and wherein the lemon juice powder comprises between about 0.03 and 0.15 weight percent of the weight of the hollandaise sauce.
